(19) United States
(12) Patent Application Publication
(10) Pub. No.: US 2026/0340746 A1
(43) Pub. Date: Oct. 29, 2026

(54) INFORMATION PROCESSING METHOD, INFORMATION PROCESSING DEVICE, AND NON-TRANSITORY COMPUTER-READABLE MEDIUM

(71) Applicant: LegalOn Technologies, Inc., Tokyo (JP)

(72) Inventors: Shinya KATSUMATA, Tokyo (JP); Tomoe SUZUKI, Tokyo (JP); Naruhiko HIRAKI, Tokyo (JP); Yasuhiro KITAMURA, Tokyo (JP); Yumika YOSHINO, Tokyo (JP)

(21) Appl. No.: 19/713,741

(22) Filed: Jun. 19, 2026

Related U.S. Application Data
(63) Continuation of application No. PCT/JP2024/013072, filed on Mar. 29, 2024.

(30) Foreign Application Priority Data
Dec. 21, 2023 (JP) 2023-216109

(51) Int. Cl. G06Q 50/18; G06F 21/62; H04L 51/216

(52) U.S. Cl. CPC G06Q 50/18; G06F 21/6218; H04L 51/216

(57) ABSTRACT

In an information processing method according to an embodiment, for each of at least one legal case, one or a plurality of pieces of message information each including at least displayed content and time information is stored, and message information regarding a first legal case, which is one of the legal cases, among the one or the plurality of pieces of message information is arranged and displayed as information regarding the first legal case on a basis of time indicated in the time information. When receiving an input of a message from a user in association with the first legal case, message information including the input message is generated and stored in association with the first legal case.

### CROSS-REFERENCE TO RELATED APPLICATION

This application is a continuation of International Application No. PCT/JP2024/013072, filed on Mar. 29, 2024. The entire contents of each of the above-identified applications are incorporated herein by reference.

### BACKGROUND

### Technical Field

Embodiments of the present disclosure relate to an information processing method, an information processing device, and a non-transitory computer-readable medium.

In legal work, as case information regarding each case, there may be various kinds of information such as a message between persons in charge, an electronic mail, and a document file such as a contract document. These pieces of information are often stored in different places or different applications depending on the information. Therefore, when confirming the case information regarding a certain case, a person in charge of legal work may have trouble with finding the pieces of case information stored in different places by search or the like and confirming the content. Related techniques have been proposed for managing information in legal work (for example, e.g., Japanese Patent Application Laid-Open Publication No. 2019-114264 (JP 2019-114264 A)).

### SUMMARY

In an information processing method according to an embodiment, for each of at least one legal case, one or a plurality of pieces of message information each including at least displayed content and time information is stored, and message information regarding a first legal case, which is one of the legal cases, among the one or the plurality of pieces of message information is arranged and displayed as information regarding the first legal case on a basis of time indicated in the time information.

### BRIEF DESCRIPTION OF DRAWINGS

FIG. 1 is a schematic diagram for describing an overview of a case management system;

FIG. 2 is a block diagram illustrating an example of a hardware configuration of an information processing device;

FIG. 3 is a block diagram illustrating an example of a hardware configuration of a terminal device;

FIG. 4 is a diagram illustrating an example of a functional configuration of the information processing device;

FIG. 5 is a diagram illustrating an example of a timeline display screen displayed on the terminal device;

FIG. 6 is a diagram illustrating an example of a timeline area in which message information and update operation information are displayed;

FIG. 7 is a diagram illustrating an example of a transmission box;

FIG. 8 is a diagram illustrating an example of a transmission box including a file input box;

FIG. 9 is a diagram illustrating the timeline area in which message information including a mention is displayed;

FIG. 10 is a diagram illustrating an example of a title image;

FIG. 11 is a diagram illustrating an example of the timeline area in which mail information and the message information are displayed;

FIG. 12 is a diagram illustrating an example of a mail thread area in which the mail information is displayed;

FIG. 13 is a diagram illustrating an example of the timeline display screen displayed on the terminal device in a case where a user is a person in charge of legal work or a legal manager;

FIG. 14 is a diagram illustrating an example of the timeline area in which the message information may be displayed in a case where the user is the person in charge of legal work or the legal manager; and

FIG. 15 is a diagram illustrating an example of the timeline area in which the message information may be displayed in a case where the user is a person in charge of a case.

### DETAILED DESCRIPTION

Hereinafter, embodiments will be described in detail with reference to the drawings. Note that, in the following description, components having substantially the same functions and configurations are denoted by the same reference signs, and description will be made if necessary. In addition, the embodiments can be combined with other embodiments, modifications, and conventional techniques.

An object of the present disclosure is to provide an information processing method, an information processing device, and a program for appropriately managing or referring to case information regarding a legal case.

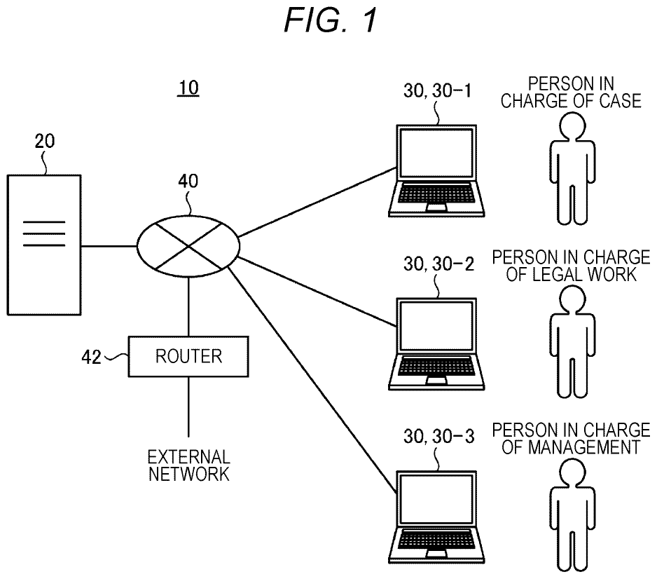

FIG. 1 is a schematic diagram for describing an overview of a case management system 10 according to the present embodiment.

In the present specification, a legal case may be a unit of work, and may refer to, for example, a unit in which a person in charge of legal work of a company is requested to prepare a contract or a legal document and review a legal document. The unit as a legal case can be determined as appropriate, and may be, for example, for each request or for each contract. Furthermore, for example, the unit may be a group of conversations or certain data such as a channel or thread of a social networking service (SNS), a thread of an electronic mail, or a case registered in a system. Furthermore, the unit as a legal case may be determined by a rule of a company to which a user belongs such as a regulation or a policy, the user himself/herself, setting of a vendor that provides the system, or the like. In addition, preferably, each legal case can be specified by, for example, a case number, a case name, a reception date, a counterparty, a requester, a client name, or the like.

In the present specification, information regarding a legal case may be referred to as case information. The case information may include, for example, various types of information such as an electronic mail or a message of a request for a case, a file of a contract document or the like, a document file of a contract document regarding a related or similar contract, another related file, a message transmitted by a person in charge of the case, a person in charge of legal work, and a legal manager, transmission/reception information by an electronic mail or a message application transmitted/received to/from an external user who does not have a user account or the like of the case management system 10 or does not have authority regarding the legal case, and a person in charge change history of assigning or changing the person in charge of legal work or the like.

In the present specification, the legal document may include a contract document, terms and conditions, internal regulations, and other legal documents in general. In addition, text data included in a message or a file handled in the case management system 10 may be described in any language.

The case management system 10 according to the present embodiment may include an information processing device 20 and a plurality of terminal devices 30 (for example, a terminal device 30-1, a terminal device 30-2, and a terminal device 30-3). For example, the information processing device 20 may be provided on the cloud and may be connected to each of the plurality of terminal devices 30 via a network 40 and a router 42.

Each of the plurality of terminal devices 30 of the present embodiment is used by the user. Accordingly, the information processing device 20 of the present embodiment can provide a case management service for managing case information regarding a legal case for each legal case to the user who uses each of the plurality of terminal devices 30.

In the present embodiment, the user may be a person in charge of a case, a person in charge of legal work, or a legal manager, and each of the plurality of terminal devices 30 may be used by the person in charge of the case, the person in charge of legal work, or the legal manager.

The person in charge of a case according to the present embodiment may be a user who makes a contract for or handles the legal case. Examples thereof include an employee of a sales department belonging to a department other than a legal department. For example, in a case where a contract or the like is made, or in a case where legal handling or consideration is required, the person in charge of the case registers a legal case in the information processing device 20 using the terminal device 30. Note that a plurality of persons in charge of a case may exist for each legal case.

The person in charge of legal work of the present embodiment may be, for example, a user who performs legal handling and consideration for a legal case registered by the person in charge of the case. The person in charge of legal work is assigned, for example, for each legal case. A plurality of persons in charge of legal work may be assigned to each legal case. The person in charge of legal work reviews a document file such as a contract document for the assigned legal case using the terminal device 30, for example. Furthermore, the person in charge of legal work may transmit a message to the person in charge of the case to give advice or the like to the person in charge of the case.

The legal manager of the present embodiment may be a user who is a manager of the legal department and manages the person in charge of legal work. In a case where a legal case occurs, the legal manager of the present embodiment can assign any person in the legal department as the person in charge of legal work for the legal case by using the terminal device 30.

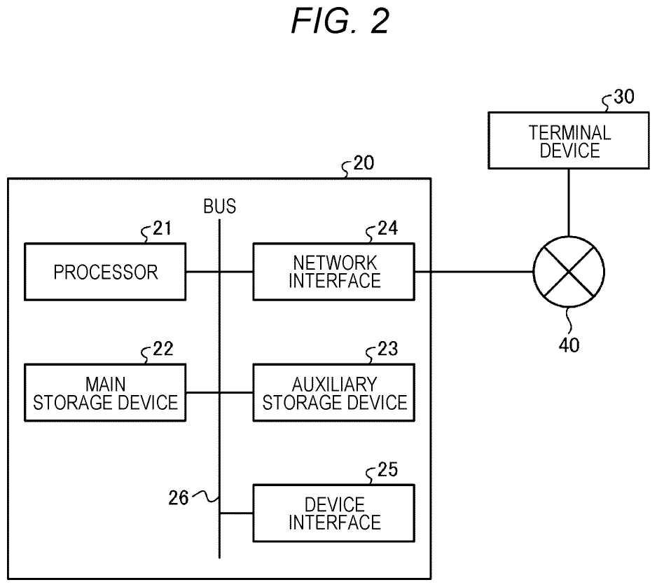

FIG. 2 is a block diagram illustrating an example of a hardware configuration of the information processing device 20 according to the embodiment. For example, the information processing device 20 can perform various types of processing in response to a request from each of the plurality of terminal devices 30 via the network 40, and can cause the plurality of terminal devices 30 to display an image via the network 40.

The information processing device 20 of the present embodiment may be a computer, and may include, as an example, a processor 21, a main storage device 22 (memory), an auxiliary storage device 23 (storage), a network interface 24, a device interface 25, and a bus 26 that connects the components to each other.

The information processing device 20 illustrated in FIG. 2 includes one component per kind, but may include a plurality of components of the same type. In addition, one information processing device 20 is illustrated in FIG. 2, but software may be installed in a plurality of computers, and each of the plurality of computers may execute the same or different part of processing of the software. In this case, there may be a form of distributed computing in which each of the computers communicates via the network interface 24 or the like to execute processing. That is, the information processing device 20 may be configured as a system that implements various functions described later by one or a plurality of computers executing commands stored in one or a plurality of storage devices.

Various computations of the information processing device 20 may be executed in parallel processing using one or a plurality of processors 21 or using a plurality of computers via the network 40. In addition, various computations may be distributed to a plurality of computing cores in the processor 21 and executed in parallel processing. As described above, the processing of the information processing device 20 may be in a form of parallel computing by one or a plurality of computers. In addition, a part or the whole of the processing, means, and the like of the present disclosure may be executed by at least one of another computing processing device and storage device capable of communicating with the information processing device 20 via the network 40.

The processor 21 may be an electronic circuit (a processing circuit, processing circuitry, a central processing unit (CPU), a graphics processing unit (GPU), a field programmable gate array (FPGA), an application specific integrated circuit (ASIC), or the like) including a control device and a computing device of the information processing device 20. In addition, the processor 21 may be a semiconductor device or the like including a dedicated processing circuit. The processor 21 may be achieved by an optical circuit using an optical logic element without being limited to an electronic circuit using an electronic logic element. In addition, the processor 21 may include a computing function based on quantum computing.

The processor 21 can perform computing processing on the basis of data and software (program) input from each device or the like of an internal configuration of the information processing device 20, and can output a computation result and a control signal to each device or the like. The processor 21 may control each component constituting the information processing device 20 by executing an operating system (OS) of the information processing device 20, an application program, or the like.

The information processing device 20 may be achieved by one or a plurality of processors 21. Here, the processor 21 may refer to one or a plurality of electronic circuits disposed on one chip, or may refer to one or a plurality of electronic circuits disposed on two or more chips or two or more devices. When a plurality of electronic circuits are used, the electronic circuits may communicate in a wired or wireless manner.

The main storage device 22 may be a storage device that stores commands executed by the processor 21, various types of data, and the like, and information stored in the main storage device 22 may be read by the processor 21. The auxiliary storage device 23 may be a storage device other than the main storage device 22, and may include, for example, a storage medium such as a hard disk drive (HDD) or a flash memory. Note that each of these storage devices may mean any electronic component capable of storing electronic information, and may be a semiconductor memory. The semiconductor memory may be either a volatile memory or a nonvolatile memory. A storage device for storing various types of data used in the information processing device 20 may be achieved by the main storage device 22 or the auxiliary storage device 23, or may be achieved by a built-in memory built in the processor 21. For example, the main storage device 22 and the auxiliary storage device 23 may be collectively referred to as a storage unit or a storage device.

In a case where the information processing device 20 has functions of storage management of message information, storage management of update operation information, storage management of files, storage management of transmission and reception of electronic mails, and the like, the auxiliary storage device 23 may store, for example, message information acquired from each of the plurality of terminal devices 30 via the network 40, update operation information related to an update operation executed in the information processing device 20, document files of legal documents transmitted and received via the network 40, electronic mails transmitted and received via the network 40, and the like.

To one storage device (the main storage device 22 and/or the auxiliary storage device 23), a plurality of processors 21 may be connected (coupled), or a single processor 21 may be connected. A plurality of storage devices may be connected (coupled) to one processor 21. In a case where the information processing device 20 includes at least one storage device and a plurality of processors connected (coupled) to the at least one storage device, at least one processor among the plurality of processors may be connected (coupled) to the at least one storage device. In addition, this configuration may be achieved by a storage device and the processors 21 included in a plurality of computers. Furthermore, a storage device may be integrated with the processor 21 (for example, a cache memory including an L1 cache and an L2 cache).

The network interface 24 may be an interface for connecting to the network 40 in a wireless or wired manner. As the network interface 24, an appropriate interface is only required to be used, such as one conforming to an existing communication standard. The network interface 24 may cause information to be exchanged with an external device connected via the network 40. Note that the network 40 may be any of a wide area network (WAN), a local area network (LAN), a personal area network (PAN), and the like, or may be a combination thereof, and only needs to be one that allows exchanges of information between the information processing device 20 and an external device. Examples of the WAN may include the Internet, examples of the LAN include IEEE802.11 and Ethernet (registered trademark), and examples of the PAN include Bluetooth (registered trademark) and near field communication (NFC).

The device interface 25 may be an interface such as a universal serial bus (USB) directly connected to an output device such as a display device, an input device, and an external device. In addition, the external device may be a storage such as a storage device (memory), a network storage, or an HDD. In addition, the external device may be a device having some functions of the components of the information processing device 20. That is, the information processing device 20 may transmit or receive a part or the whole of a processing result of the external device. The display device connected to the device interface 25 may be, for example, a liquid crystal display (LCD), a cathode ray tube (CRT), a plasma display panel (PDP), or an organic electro luminescence (EL) panel. As the input device connected to the device interface 25, for example, various input interfaces such as a keyboard, a mouse, and a touch pad can be applied. Furthermore, the output device such as a display device and the input device may be included in the information processing device 20.

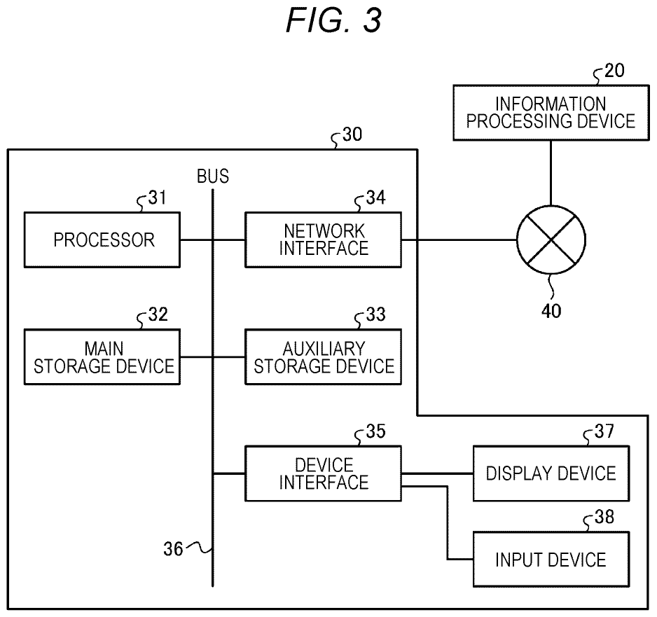

FIG. 3 is a block diagram illustrating an example of a hardware configuration of the terminal device 30 according to the embodiment.

The terminal device 30 of the present embodiment may be a computer, and may include, as an example, a processor 31, a main storage device 32 (memory), an auxiliary storage device 33 (storage), a network interface 34, a device interface 35, a bus 36 that connects the components to each other, a display device 37 connected to the device interface 35, and an input device 38 connected to the device interface 35. Note that specific hardware configurations of the processor 31, the main storage device 32, the auxiliary storage device 33, the network interface 34, the device interface 35, and the bus 36 are similar to those of the processor 21, the main storage device 22, the auxiliary storage device 23, the network interface 24, the device interface 25, and the bus 26, respectively, and therefore description thereof is omitted. The terminal device 30 may be a personal computer (PC), a tablet terminal, or the like, but is not limited thereto.

The display device 37 is a display device such as an LCD, a CRT, a PDP, or an organic EL panel. The display device 37 displays a display image or the like on the basis of an instruction from the processor 31.

The input device 38 may be a device such as a keyboard, a mouse, or a touch panel. The user can input various operation instructions by using the input device 38. The instruction input from the input device 38 is sent to the processor 31.

Note that the terminal device 30 may include another external device (for example, a camera, a microphone, a motion capture, or various sensors) connected via the device interface 25 in order to operate and edit document data.

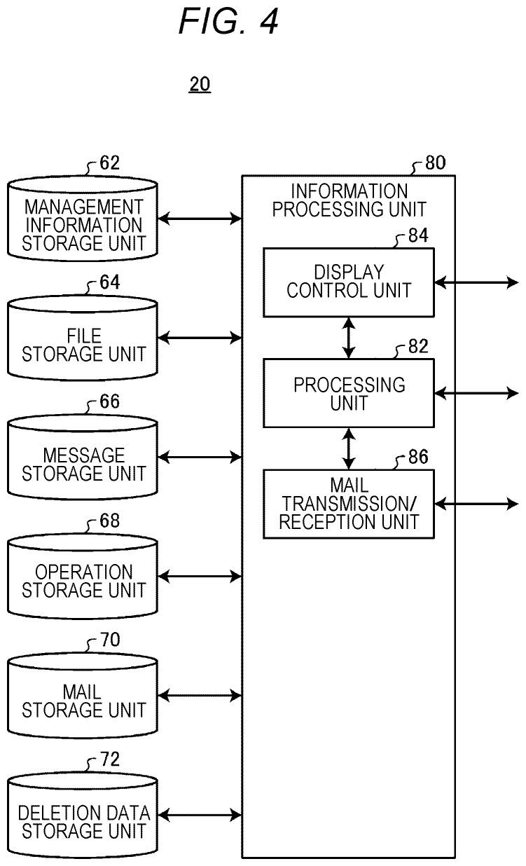

FIG. 4 is a diagram illustrating an example of a functional configuration of the information processing device 20 according to the present embodiment. Note that the processing related to the case management system 10 performed in the information processing device 20 and the terminal device 30 in the following description may be performed in the information processing device 20, may be performed in the terminal device 30, or may be performed by two or more of the information processing device, the terminal device, and an information processing device outside the system of the case management system 10.

The information processing device 20 according to the present embodiment may include, in the storage unit, a management information storage unit 62, a file storage unit 64, a message storage unit 66, an operation storage unit 68, a mail storage unit 70, a deletion data storage unit 72, and an information processing unit 80.

The management information storage unit 62 of the present embodiment may store management information for each legal case. The management information may include, for example, case identification information for identifying the corresponding legal case, information for identifying a user authorized to write and refer to case information regarding the corresponding legal case, a title of the corresponding legal case, and a case outline regarding the corresponding legal case.

Note that, in the present specification, the case outline may include two pieces of text of “summary” and “topic”. “Summary” may be a text of a summary of the circumstances of a legal case, particularly the past circumstances. “Topic” may be a matter related to review including changes of a legal document related to a legal case. In the present specification, text may be very short information such as only one word, only one sentence, and itemized writing as well as a plurality of sentences.

The file storage unit 64 of the present embodiment may store a file in association with a legal case. Hereinafter, a document file will be described as an example of a file. The document file may be a file including text data, and may be, for example, a file including data of a legal document such as a contract document prepared for the corresponding legal case. The document file may not only be a contract document, but be a file in which other information related to the legal case is described, for example, a term sheet of the contract, minutes of negotiation, or material related to business related to the legal case.

As for the document file such as a contract document, after the initial version thereof is prepared, the version may be updated by receiving modification, review, and a counter proposal of the counterparty. In this case, the file storage unit 64 can store one or more versions for each document file. The file storage unit 64 of the present embodiment can read a document file of a designated version by designating a file name and a version. In addition, the file storage unit 64 can similarly store a document file for each version not only for the contract document but also for other legal documents or related documents.

The message storage unit 66 of the present embodiment may store one or a plurality of pieces of message information for each legal case. The message information may include information about a message displayed to the user and time information related to time.

The time information may be represented in a data format representing date and time or time, or may be any information or format that can represent time, such as information indicating the same time as other message information.

The message information may be, for example, chat message information including, for each legal case, a chat message generated by a user authorized for the corresponding legal case and generation time information indicating time of generation as time information. The chat message may be an example of a message. The chat message is, for example, a text generated on the case management system 10 via a transmission box or the like to be described later by a user authorized for the legal case to be handled. Furthermore, the chat message may include, as a destination of the message, for example, mention information specifying a user or the like to which a notification is to be transmitted indicating that the message has been transmitted to the user.

Further, the message information may include file information for identifying the file stored in the file storage unit 64. The file information may include, for example, a file name, a version number, and a storage location of the file.

The mail storage unit 70 of the present embodiment may store one or a plurality of pieces of mail information for each legal case. The mail information may be an example of the message information. Each of the one or the plurality of pieces of mail information may include, for example, information of a transmitted/received mail and transmission/reception time information indicating time when the information is transmitted/received. A mail text may be an example of a message, and the transmission/reception time information may be an example of time information included in the message information.

The mail information may be, for example, an electronic mail according to a protocol of the Internet. For example, an electronic mail address capable of transmitting and receiving an electronic mail is set in the information processing device 20. Then, for example, information for identifying the legal case is included at a predetermined character position of the message ID included in the header in the electronic mail. Accordingly, the mail storage unit 70 can discriminate and store one or a plurality of pieces of mail information for each legal case. Note that the information processing device 20 may receive a copy of the content of the electronic mail without transmitting and receiving the electronic mail.

Note that the information for identifying the legal case is not limited to the message ID, and may be, for example, an electronic mail address or the like. Further, the position may be any position in the data. Furthermore, the information to be transmitted or received is not limited to an electronic mail, and may be, for example, information transmitted and received by another communication program such as an SNS or a chat program as long as the information can be transmitted to an external user and the information can be received from the external user. Note that a message transmitted and received without using an electronic mail is also referred to as mail information in the present specification.

In the present embodiment, the message information transmitted from the external user by receiving an electronic mail or transmitted to the external user can be accumulated in the case management system 10. In the present specification, the external user may be a user who is not authorized in the system for the legal case. For example, the external user may be a person in charge in a negotiation counterparty (for example, a counterparty of the contract) or an attorney in charge of the legal case, who transmits and may receive the mail information.

The message information may include display authority information. The display authority information may be information defining display authority of the message information of the user. In the present embodiment, a first authorized user to whom the display authority of the first level may be given and a second authorized user to whom the display authority of the second level higher than the first level may be given are set as users for each legal case. In addition, in the present embodiment, the person in charge of a case who requests handling of a legal case is the first authorized user to whom the display authority of the first level is given. The person in charge of legal work and the legal manager may be the second authorized users to whom the display authority of the second level is given to display a second level message in addition to a first level message. Therefore, the information processing device 20 of the present embodiment can cause more information to be displayed to the person in charge of legal work and the legal manager than to the person in charge of the case. By assigning the display authority information to the message in this manner, it may be possible to select a message to be displayed to a user for which the display authority has been set or a message not to be displayed to the user. Note that the display authority or the display authority information may be of a plurality of types so that the message information can be appropriately displayed, and is not limited to broadening the range of the message information to be displayed according to the level as described above. Furthermore, the number of authority levels is not limited to two levels of the first level and the second level, and may be, for example, N levels (N is an integer of 2 or more).

In the present embodiment, the display authority information may be included in the message information generated by the person in charge of legal work and the legal manager who are the second authorized users. As an example, the display authority information may indicate whether or not the message information is shared with the person in charge of the case who is the first authorized user. In the present embodiment, in a case where the included display authority information indicates that the message information is to be shared with the first authorized user, the message information may be displayed to the first authorized user. On the other hand, in a case where the included display authority information indicates that the message information is not to be shared with the first authorized user, the message information may not be displayed to the first authorized user but displayed only to the second authorized user. By doing so, information that does not need to be viewed by the person in charge of the case or a user who is not in charge of legal work, for example, specialized information related to legal work such as interpretation of provisions and guidelines, consultation between persons in charge of legal work, internal views within the legal organization, and the like, can be recorded relatively easily in association with the legal case.

The display authority information may be set for each piece of message information, and may be set under any conditions such as a legal case unit, a user unit for registering message information, and a type of message information on a management screen or the like. In addition, the setting may not be necessarily performed by a user having certain authority.

The operation storage unit 68 of the present embodiment may store one or a plurality of pieces of update operation information for each legal case. Each of the one or the plurality of pieces of update operation information may include, for example, content or an outline of an update operation by the user for the case information related to the corresponding legal case, and operation time information indicating time of the update operation. The content or the outline of the update operation may be an example of a message, and the operation time information may be an example of time information included in the message information. Furthermore, each of the one or the plurality of pieces of update operation information may include, for example, user identification information for identifying the user who has performed the update operation.

In the present embodiment, the update operation for the case information related to the legal case may be, for example, preparation of a case, new setting or a change of an answer deadline of the case, a change of a status of the case, an operation of deleting a case outline, an operation of deleting a message, an operation of changing content of a message, an operation of changing a title, an operation of newly registering a case outline, an operation of changing a case outline, an operation of adding a person in charge of the case or a person in charge of legal work, an operation of registering, deleting, and changing a file, and the like. The update operation for the case information related to the legal case may be these operations, and may include other operations.

The deletion data storage unit 72 of the present embodiment may store deletion information of the message information. The deletion information may include information immediately before being updated due to the update operation by the user in the case information related to the legal case. As an example, the deletion information may be message information before deletion in a case where the message information is deleted, and is message information before update in a case where the message information is updated. The deletion information may include user identification information for identifying the user who has performed the update operation, and operation time information indicating the time when the update operation has been performed.

In the present embodiment, the message information may include user identification information for identifying the user who has generated or updated the message information.

Note that the message information may include other related information such as review result information and research information. The review result information may be, for example, a result generated or acquired in review processing to be described later. The review information as the message information may be result text, a summary, a link to a related file, or the like. The research information may be information about research related to the legal case. The research information can be obtained, for example, by searching a database of a law, a judgment example, a guideline, a book, or the like or performing a web search by making inquiries into Large Language Models (hereinafter, it may be referred to as LLM) or by using a keyword input search. The research information as the message information may be result text, a summary, a link to a related document and file, or the like. Acquisition of the related information such as the review processing, the research processing, and the inquiries may be preferably performed in the case management system 10. Accordingly, the related information can be appropriately acquired and displayed as the message information.

One piece of message information may be associated with a plurality of legal cases. In this case, the message information may be displayed on each of the screens of the legal cases with which the message information is associated. Examples of such message information may include a chat message and an operation that affect a plurality of legal cases. That is, in the present specification, “for each legal case” is not limited to a case where one piece of message information is associated with only one legal case.

The information processing unit 80 according to the present embodiment may execute processing related to the above-described message information. The information processing unit may be implemented as a function implemented by the processor 21, for example. More specifically, the information processing unit 80 may be implemented by the processor 21 reading and executing a program stored in the main storage device 22, the auxiliary storage device 23, or the like. The program executed by the processor 21 may be provided by being recorded in a computer-readable recording medium such as a CD-ROM, a flexible disk, a CD-R, and a digital versatile disk (DVD) as a file in an installable format in a computer or an executable format. In addition, this program may be stored on a computer connected to a network such as the Internet and provided by being downloaded via the network. In addition, this program may be provided or distributed via a network such as the Internet.

The information processing unit 80 of the present embodiment may accept access from the terminal device 30 used by each user via the network 40. For example, the information processing unit 80 may accept access via a user interface displayed by a browser program executed by the terminal device 30. The information processing unit 80 may update and read information stored in the management information storage unit 62, the file storage unit 64, the message storage unit 66, the operation storage unit 68, the mail storage unit 70, and the deletion data storage unit 72 according to access from the terminal device 30 used by each user. Furthermore, the information processing unit 80 may generate a display image according to access from the terminal device 30 used by each user, and cause the terminal device 30 that has accessed to display the generated display image. The terminal device 30 may execute, for example, a browser program and may display the display image generated by the information processing unit 80 via the browser program.

Furthermore, the information processing unit 80 of the present embodiment may transmit an electronic mail or an SNS message to an external user according to access from the terminal device 30 used by a user. In addition, the information processing unit 80 may receive an electronic mail transmitted from an external user, specify a legal case corresponding to the received electronic mail, and store the electronic mail in the mail storage unit 70 in association with the specified legal case.

Such an information processing unit 80 may include a processing unit 82, a display control unit 84, and a mail transmission/reception unit 86.

Hereinafter, processing of the information processing unit 80 including the processing unit 82, the display control unit 84, and the mail transmission/reception unit 86 will be described in more detail with reference to the drawings illustrating examples of display images.

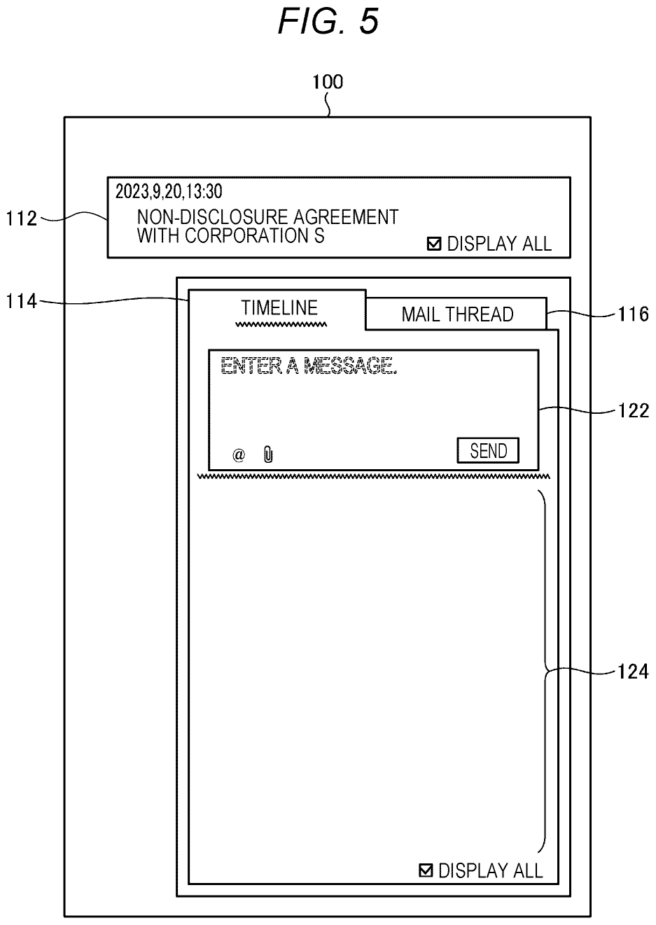

FIG. 5 is a diagram illustrating an example of a timeline display screen 100 displayed on the terminal device 30.

In the present embodiment, the user may access case information regarding a first legal case, which is one of legal cases managed by the information processing device 20, using the terminal device 30. For example, the user may access the information processing device 20 from the menu screen, or may access the information processing device 20 from link information for accessing information regarding the first legal case described in an electronic mail or the like. Then, the processing unit 82 may determine whether or not the accessing user is authorized for the first legal case on the basis of the management information regarding the first legal case stored in the management information storage unit 62. In a case where the processing unit 82 determines that the accessing user is authorized for the first legal case, the display control unit 84 may display the timeline display screen 100 as illustrated in FIG. 5 on the terminal device 30 used by the user. As a result, the user can refer to the case information regarding the first legal case.

Note that the legal case may be prepared on the basis of information regarding the case, such as request content, received from a user who is a person in charge of the case via a user interface such as an electronic mail or a reception form provided in a browser program, for example. The management information may be generated or the message information may be generated on the basis of the information received at the time of preparing the legal case.

The legal case can be prepared by various methods as well as by reception of an electronic mail or the like. For example, it can be prepared by uploading a file including case information, for example, a tabular file (for example, a spreadsheet file) including information necessary for preparing a legal case, management information, message information, and the like. Accordingly, it may be possible to easily register, in the system, information regarding a legal case managed by a spreadsheet before introducing the system or information regarding a legal case output from another system.

Furthermore, for example, it may be prepared by uploading an electronic mail file such as .eml to the system. In this case, each mail may be prepared as one legal case, similarly to a case where files of a plurality of electronic mails may be uploaded to the system and cases may be prepared by receiving the electronic mails. By doing so, a past legal case in which no electronic mails may be currently transmitted or received can be registered as a case and used as an information source.

Note that a legal case already registered as a legal case in a different system may be transferred (imported) from the different system and prepared in the present system.

The timeline display screen 100 of the present embodiment may include, for example, a title display unit 112, a message information display unit 114, and a mail thread display unit 116. In the present embodiment, the display control unit 84 may display one of the message information display unit 114 and the mail thread display unit 116 on the front side of the timeline display screen 100 in response to an operation such as clicking a button by the user. Note that, in the present specification, the button may be an example of a user interface that enables a predetermined operation to be performed.

The title display unit 112 may include management information regarding the first legal case stored in the management information storage unit 62. For example, the display control unit 84 may switch between displaying the entire title display unit 112 and displaying a part of the title display unit 112 according to the operation by the user.

The message information display unit 114 of the present embodiment may include a transmission box 122 and a timeline area 124. The transmission box 122 may be an example of a user interface for a user authorized for the first legal case to input a chat message as message information regarding the first legal case, transmit the chat message to the information processing device 20, and store the chat message in the message storage unit 66.

In the timeline area 124 of the present embodiment, message information regarding the first legal case among one or a plurality of pieces of message information stored in the message storage unit 66 may be displayed. Furthermore, in the timeline area 124, update operation information regarding the first legal case among one or a plurality of pieces of update operation information stored in the operation storage unit 68 may be displayed. Furthermore, in the timeline area 124, mail information regarding the first legal case among one or a plurality of pieces of mail information stored in the mail storage unit 70 may be displayed. The display control unit 84 may display the message information including the chat message information, the update operation information, and the mail information in the timeline area 124 in order of time information associated with each piece of message information, for example, such that a newer message is arranged at the upper part of the screen.

Note that, in the present embodiment, both the message and the time information in the message information are displayed, but the time information does not need to be displayed.

As the message or the time information, the stored content thereof may not be displayed. For example, the message that has been processed or edited, such as machine translation or summary, may be displayed. Further, as the message information, the entire text may not need to be displayed on the timeline display screen, and lines except appropriate lines from the top may be omitted, or only a part determined to be important by the machine learning model or the like may be displayed. When the user wants to view all of the message information or another part of the message information, the message information may be viewable by an operation such as pressing a “display all” button. In particular, in the information of the electronic mail, one piece of message information may be lengthened or the information may overlap due to the cited reply, the transfer, or the like, but the viewability can be enhanced by displaying the information in this manner. Note that, in the message information, a part considered to have low importance may be deleted or hidden so as not to be displayed on the timeline for reasons such as overlapping with the message information already stored, or being merely greetings and having low importance.

As the time information, a number obtained by rounding the stored time in units of seconds or minutes may be displayed, or timing may be displayed such as how many hours, how many days, or how many months ago from the present time.

In the mail thread display unit 116 of the present embodiment, one or a plurality of pieces of mail information associated with the first legal case and stored in the mail storage unit 70 may be displayed. Similarly to the message information, the display control unit 84 arranges and may display the mail information in the mail thread display unit 116 in order of time information.

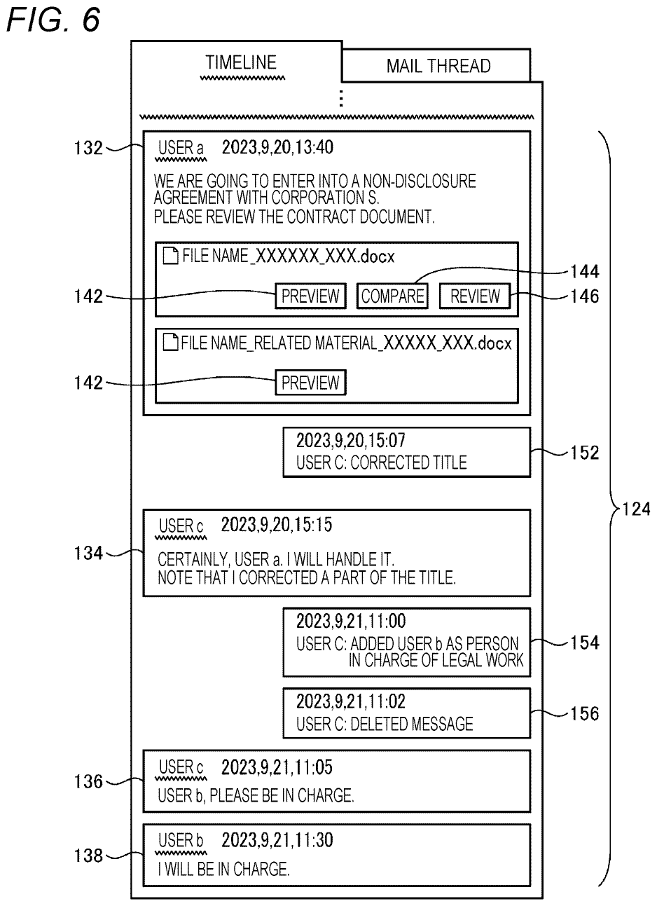

FIG. 6 is a diagram illustrating an example of the timeline area 124 in which the message information and the update operation information are displayed.

In the example in FIG. 6, the display control unit 84 may arrange and display, to the user authorized for the first legal case, the chat message information regarding the first legal case and the update operation information regarding the first legal case in the timeline area 124 in order of time indicated in the generation time information and time indicated in the operation time information. Accordingly, the user can grasp in time series what kind of message has been written and what kind of update operation has been performed for the first legal case by confirming the timeline area 124.

For example, in the timeline area 124 in FIG. 6, first message information 132, second message information 134, third message information 136, and fourth message information 138 may be displayed as the chat message information. In each piece of the message information, as illustrated in FIG. 6, the display control unit 84 may display, in the timeline area 124, at least user identification information for identifying the user who has generated the message information, generation time information, which is an example of information regarding time, indicating time when the message information has been generated or registered, and message information including a message that may be text generated by the user.

The first message information 132 of the present embodiment may include, as file information, a file name, which is information for identifying a document file stored in the file storage unit 64. In a case where the file information is included in the message information, the display control unit 84 may further display the file name in the timeline area 124. In this manner, the file information may be included in the chat message information or the mail information.

In addition, the display control unit 84 of the present embodiment may display not only the file information but also an item that prompts the user to perform an operation related to the file. For example, in the example in FIG. 6, a preview button 142, a comparison button 144, and a review button 146 may be displayed.

In the present embodiment, when the preview button 142 is pressed (an example of an operation) by the user, the processing unit 82 may read a document file designated by the file name from the file storage unit 64, and cause the terminal device 30 to display the file by retrieving an application program capable of reading the document file or to display the file on the same application (browser in the present embodiment) as that displaying the timeline display screen 100, preferably in a file viewing area set at a different position from the position of the timeline display screen 100. By doing so, the user can easily confirm the document file having the file name included in the message information.

Furthermore, in a case where the document file is a specific type of document, for example, the display control unit 84 may display not only the file name but also an item corresponding to an operation performed on the specific type of document. In the present embodiment, the comparison button 144 and the review button 146 may be displayed. The button corresponding to this operation may be displayed corresponding to the display authority, for example. For example, the review button 146 may be displayed to the second authorized user and may be not displayed to the first authorized user. That is, the display authority may determine whether or not a function of the case management system 10 can be used as well as whether or not to display.

In the present embodiment, in a case where the comparison button 144 is pressed by the user, the processing unit 82 may read, from the file storage unit 64, a document file of a previous version, a document file prepared for a legal case related to or similar to the first legal case, for example, a document file such as a contract document regarding a related or similar contract, or the like, and displays, on the terminal device 30, a screen in which the content of the two document files and a highlighted difference between the two document files may be displayed by retrieving an application program capable of reading the document file or to display the file in a file viewing area set on the browser. By doing so, the user can confirm the document file related to the document file having the file name included in the message information and easily grasp the necessary difference.

In the present embodiment, in a case where the review button 146 is pressed by the user, the processing unit 82 may read, from the file storage unit 64, a specific type of document file designated by the file name, for example, a contract document, and cause the terminal device 30 to display the document file by retrieving a dedicated application program for performing review to be described later on a specific type of document file or to display the document file in a review viewing area set on the browser. For example, the dedicated application program may be a program for a user of the legal department to refer to, and confirm and correct a specific type of document file such as a contract. By doing so, the user can review the specific type of document file having the file name included in the message information. Note that the case management system 10 may perform processing of determining whether the received document file is a specific type of document file, for example, whether the received document file may be a contract document or not.

Note that such an operation may include downloading of a file, editing of a document file, and the like in addition to the above.

Further, in the timeline area 124 in FIG. 6, first update operation information 152, second update operation information 154, and third update operation information 156 may be displayed as the update operation information. As illustrated in these pieces of update operation information, the display control unit 84 of the present embodiment may display at least user identification information for identifying the user who has performed the update operation, operation time information indicating the time when the update operation has been performed, and operation information including the content of the update operation in the timeline area 124. As a result, the user can confirm the update history of the case information regarding the first legal case in time series.

FIG. 7 is a diagram illustrating an example of the transmission box 122.

The user can input chat message information by inputting a message that may be text by using the terminal device 30 in the transmission box 122 as illustrated in FIG. 7 displayed on the browser, and pressing a send button 162 after inputting the text. When receiving an input of a message from a user authorized for the first legal case, the processing unit 82 may generate message information including the input message and time information, and may write the message information in the message storage unit 66 in association with the first legal case.

The transmission box 122 of the present embodiment may include an attached file input button 164 and a mention button 166.

When the user of the present embodiment presses the attached file input button 164, the display control unit 84 may display a user interface for inputting information for specifying a file to be included in the message information. By doing so, the user can upload the file to the case management system 10 and generate file information.

When the user presses the mention button 166, the display control unit 84 can display a user interface for selecting a user authorized for the first legal case. For example, in a case where any user is selected on the selection screen after the mention button 166 is pressed, the display control unit 84 may include a mention for designating the selected user in the message. By doing so, the user can easily input the mention in the message. Note that, as a method of inputting the mention, an account name or the like may be directly input instead of the selection of the user on the selection screen. Furthermore, the mention may be input by inputting information that enables the user to be identified, such as the user's name and department, and selecting the user from among searched or recommended options.

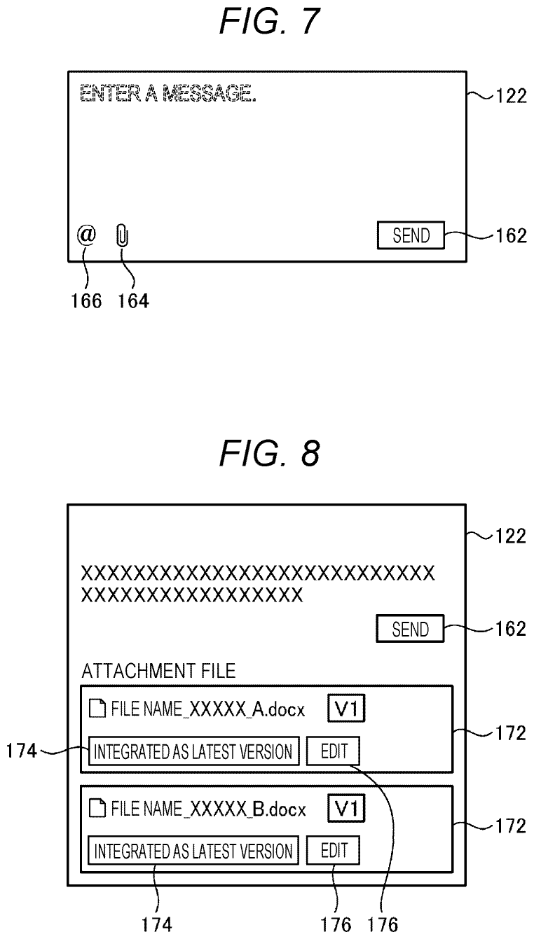

FIG. 8 is a diagram illustrating an example of the transmission box 122 including a file input box 172.

For example, the display control unit 84 may display the file input box 172 as illustrated in FIG. 8 in the transmission box 122 as a user interface for inputting information for specifying a file. The user may operate the terminal device 30 to upload a document file (an example of a file) using the file input box 172. Then, in a case where information for specifying the file is received for the first legal case, the processing unit 82 may generate message information including file information for specifying the file and may write the message information in the message storage unit 66 in association with the first legal case.

Note that the display control unit 84 may display two or more file input boxes 172 in the transmission box 122. By doing so, the processing unit 82 can generate message information including information for specifying two or more files.

In addition, the file input box 172 may include an integration button 174 and an edit button 176.

The integration button 174 of the present embodiment may be a button for registering the document file as the latest version in a document data group managed as a different version by the file storage unit 64. In a case where the integration button 174 is pressed to designate the document file, the processing unit 82 may generate message information including information indicating that the document file is the latest version of document files registered in association with the legal case. By doing so, the processing unit 82 can specify the document file of the latest version without the user being conscious of the version of the document file.

The edit button 176 of the present embodiment may be a button for a user to edit a file. In a case where the edit button 176 is pressed, the processing unit 82 reads the file designated by the file name from the file storage unit 64 and may display the file on the terminal device 30. By doing so, the user can edit the file having the file name included in the message information.

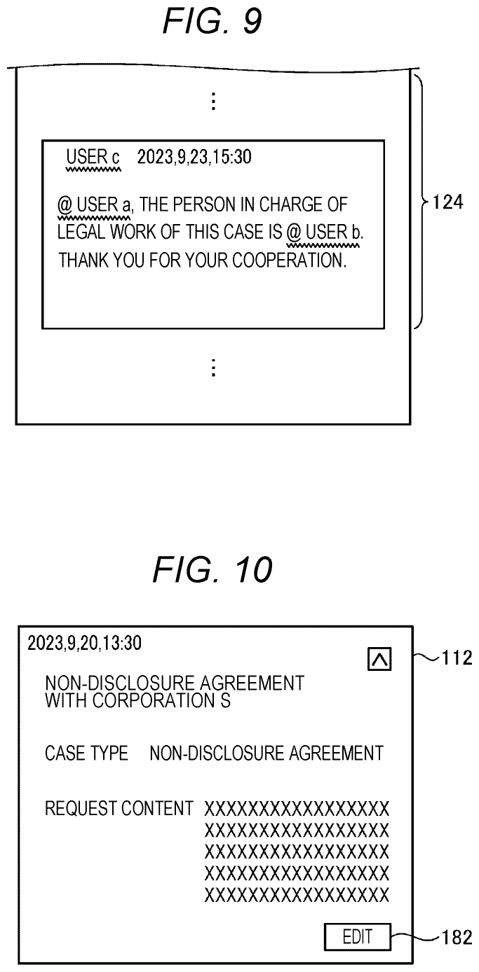

FIG. 9 is a diagram illustrating an example of the timeline area 124 in which message information including a mention is displayed.

The mention may be represented by, for example, a combination of a specific symbol such as an at mark and identification information of a designated user. In a case where the message includes a mention, the display control unit 84 may display the mention included in the message of the message information differently from the others, for example, by making the color, background color, or font of the characters different from the other parts and displaying the mention in a highlighted manner.

Furthermore, in a case where the message information including the mention in the message is input, the processing unit 82 may notify the user designated by the mention that the message has been transmitted. For example, the processing unit 82 may notify the user designated by the mention that the message has been transmitted by displaying notification that the message has been transmitted in a notification tool of the case management system 10, transmitting an electronic mail, or using a communication program such as a chat. Further, the message information in which the user is mentioned may be displayed differently from the others. For example, the message information may be displayed in a highlighted manner by making the color of the characters or the background color or font of the message information different from the other message information.

Note that the message transmitted from the transmission box of the present embodiment may be chat message information or mail information. For example, the message may be transmitted as an electronic mail from the case management system 10 to a specific destination (for example, the destination included in the mail information to which the user wants to reply), or may be linked with a communication program such as a chat and transmitted as a message on the communication program. By doing so, communication can be performed using the tool of the case management system 10 while easily associating the message with the legal case.

FIG. 10 is a diagram illustrating an example of the title display unit 112.

The display control unit 84 of the present embodiment may include management information regarding the first legal case stored in the management information storage unit 62 in the title display unit 112. In the title display unit 112, for example, a title of a case, an outline of request content, and the like may be displayed. For example, the display control unit 84 may include the title of the first legal case in the title display unit 112. Furthermore, in a case where a case outline has been prepared, the display control unit 84 may include the case outline in the title display unit 112.

Furthermore, the title display unit 112 may include an edit button 182. The edit button 182 may be a button for allowing the user to edit the information displayed on the title display unit 112. In the present embodiment, in a case where the edit button 182 is pressed, the processing unit 82 may display a user interface for editing and accepts editing of the title and the case outline.

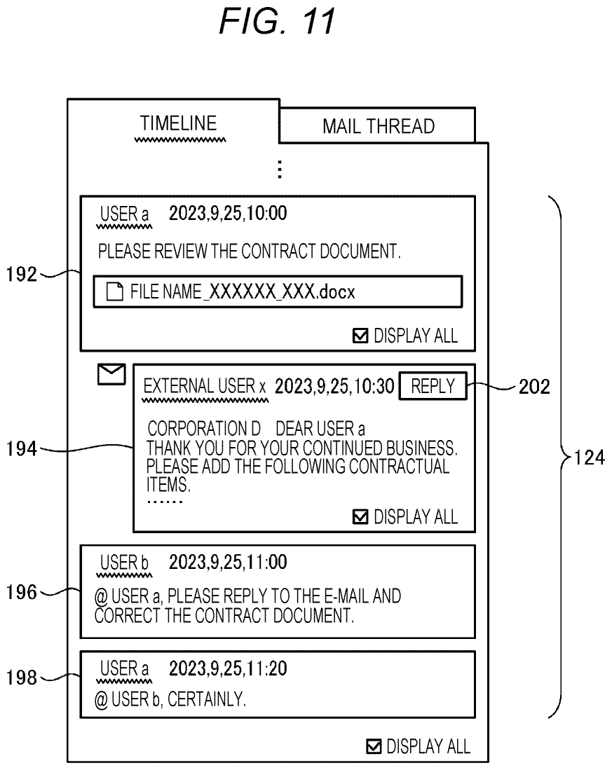

FIG. 11 is a diagram illustrating an example of the timeline area 124 in which mail information and message information are displayed.

In a case where mail information regarding the first legal case is stored in the mail storage unit 70, the display control unit 84 may display in the timeline area 124 the mail information regarding the first legal case to the user authorized for the first legal case. In this case, the display control unit 84 may arrange and display chat message information, update operation information, and mail information in order of predetermined time (for example, time indicated in the generation time information, time indicated in the operation time information, and time indicated in the transmission/reception time information) included in the information. In the present embodiment, older message information may be displayed at the upper part of the screen. Accordingly, the user can grasp in time series what kind of message has been written, what kind of update operation has been performed, and what kind of mail information has been transmitted and received for the first legal case by confirming the timeline area 124. Note that newer message information may be displayed at the upper part of the screen. Accordingly, it may be possible to easily grasp a conclusion of a legal case or information of a legal case under examination in which a conclusion is not yet fixed and message information may probably be added.

In the timeline area 124 in FIG. 11, fifth message information 192, sixth message information 196, and seventh message information 198 as the chat message information, and first mail information 194 as the mail information may be arranged and displayed in order of time.

As illustrated in the first mail information 194, the display control unit 84 may display, for example, mail information including information such as a name of an external user as a destination or a source, transmission time or reception time, included text, and image data in the timeline area 124.

Furthermore, in a case where the mail information is received from the external user, the display control unit 84 may display a reply button 202 in association with the mail information. When the reply button 202 is pressed, the mail transmission/reception unit 86 may display, for example, a mail edit screen for preparing an electronic mail, and cause the user to prepare the electronic mail. In this case, for example, it may be preferable for the mail transmission/reception unit 86 to automatically input the address of the external user included in the mail information associated with the reply button 202 pressed by the user in the mail address of the transmission destination of the electronic mail, and to include the message ID for identifying the first legal case in the header. By doing so, the mail transmission/reception unit 86 can cause the mail storage unit 70 to store the transmitted electronic mail as mail information regarding the first legal case. The mail transmission/reception unit 86 can also cause the mail storage unit 70 to store a reply electronic mail sent from the external user who has received the above-mentioned electronic mail as mail information regarding the first legal case.

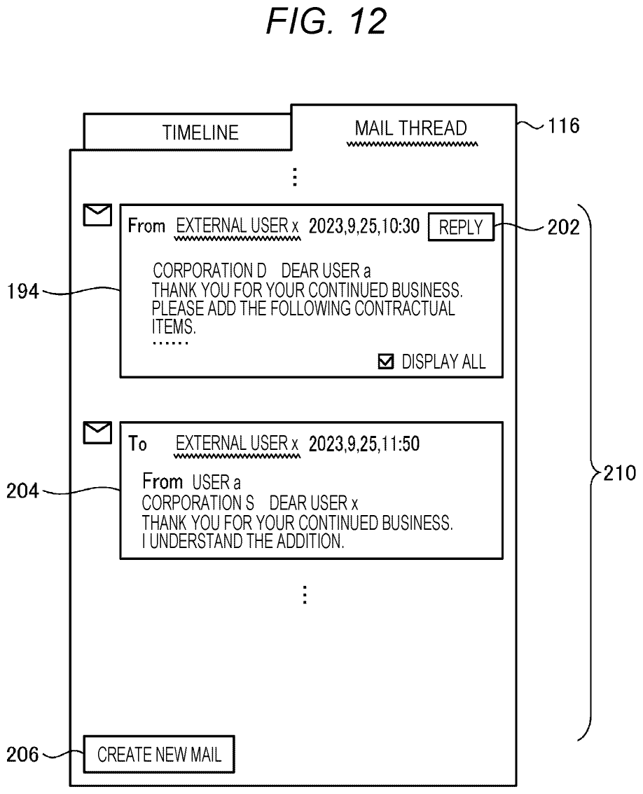

FIG. 12 is a diagram illustrating an example of a mail thread area 210 in which mail information is displayed.

The mail thread display unit 116 may include the mail thread area 210. In the mail thread area 210, mail information regarding the first legal case among one or a plurality of pieces of mail information stored in the mail storage unit 70 may be displayed.

The display control unit 84 of the present embodiment may cause the mail thread area 210 to arrange and display the mail information regarding the first legal case to the user authorized for the first legal case in order of time indicated in the transmission/reception time information. Accordingly, the user can grasp in time series what mail information has been transmitted and received for the first legal case by confirming the mail thread area 210.

The mail thread area 210 of the present embodiment may be a different area from the timeline area 124, and displaying the mail thread area 210 and displaying the timeline area 124 may be switched according to the user's operation. By doing so, the display control unit 84 can cause the user to confirm only the mail information separately from the message information and the update operation information for the first legal case. The mail information may often include exchanges with the external user, particularly, formal information of the counterparty in the negotiation regarding decision-making or the like, and may also include important information regarding the legal case. Therefore, the display control unit 84 can cause the user to confirm the mail information, which is often important, separately from other information.

For example, in the mail thread area 210 in FIG. 12, the first mail information 194 and second mail information 204 as the mail information may be arranged and displayed in order such that the mail having the older reception or transmission time, which is an example of the time information associated with the mail information is on the upper part of the screen. In this manner, the display control unit 84 can display in the mail thread area 210 the mail information including similar information to that in the timeline area 124.

Furthermore, the display control unit 84 may further display the reply button 202 in association with the mail information, similarly to the case of the timeline area 124.

Furthermore, the display control unit 84 may further display a new mail preparation button 206 in the mail thread area 210. When the new mail preparation button 206 is pressed, the mail transmission/reception unit 86 may activate, for example, an edit screen for preparing a new electronic mail, and cause the user to prepare the electronic mail. In this case, for example, the mail transmission/reception unit 86 may include, in the header of the electronic mail, identification information that can associate the thread of the electronic mail with the first legal case, for example, the message ID unique to the case or the message ID that uniquely identifies the electronic mail and transmit the electronic mail. By doing so, the mail transmission/reception unit 86 can cause the mail storage unit 70 to store the transmitted electronic mail as mail information regarding the first legal case. The mail transmission/reception unit 86 can also cause the mail storage unit 70 to store a reply electronic mail sent from the external user who has received the above-mentioned electronic mail as mail information regarding the first legal case. Note that display and non-display of the reply button 202 or the new mail preparation button 206 may be switched according to the display authority information.

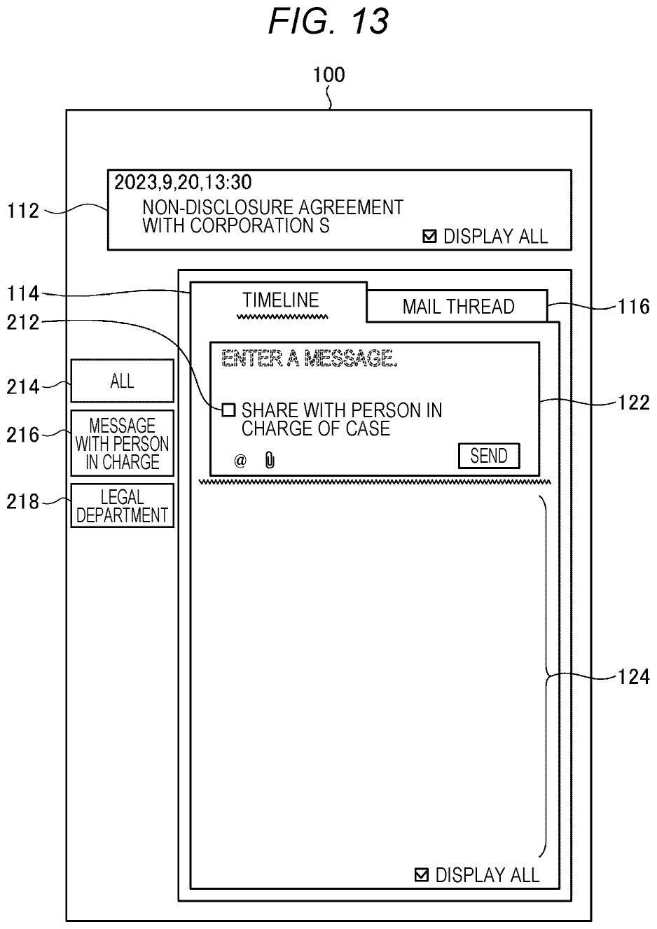

FIG. 13 is a diagram illustrating an example of the timeline display screen 100 displayed on the terminal device 30 in a case where the user is the second authorized user.

In the case management system 10 of the present embodiment, different authority levels may be set for the plurality of corresponding users. For example, the information processing device 20 may restrict the display content and the operation content further for a user having low authority than for a user having high authority. The number of levels of authority to be set may be, for example, N levels (N is an integer of 2 or more). In this case, the information processing device 20 may restrict the display content and the operation content further for the user to whom the authority at the n-th level (n is an integer of 1 or more and (N−1) or less) is set than for the user to whom the authority at the (n+1)-th level is set. Furthermore, the contents that can be displayed or operated may be designated instead of the levels.

In the present embodiment, the information processing device 20 may set the first authorized user to whom the display authority of the first level is given and the second authorized user to whom the display authority of the second level higher than the first level is given as users for each legal case. For example, the person in charge of the case may be the first authorized user to whom the display authority of the first level is given. The person in charge of legal work and the legal manager may be the second authorized users to whom the display authority of the second level is given.

In the present embodiment, in a case where the user is the second authorized user (person in charge of legal work or legal manager), the display control unit 84 may display a check box 212 in the transmission box 122 as illustrated in FIG. 13. The check box 212 may be a box for selecting whether or not to display the message information to the first authorized user (person in charge of the case) as well.

In a case where the second authorized user authorized for the first legal case may generate message information, the processing unit 82 of the present embodiment further may receive display restriction information indicating whether or not to share the message information with the first authorized user. For example, the second authorized user may select the check box 212 when sharing the message information with the first authorized user, and the second authorized user (person in charge of legal work or legal manager) may not select the check box 212 when not sharing the message information with the first authorized user. That is, the check box 212 of the present embodiment may be an example of a user interface for inputting the display restriction information for setting whether or not to display the message information according to the display authority.

When receiving an input of a message of selecting not to share the message information with the first authorized user from the second authorized user, the processing unit 82 of the present embodiment may generate message information further including the display restriction information indicating not to share the message information with the first authorized user, and write the message information in the message storage unit 66 in association with the first legal case.

When receiving an input of a message of selecting to share the message information with the first authorized user from the second authorized user, the processing unit 82 of the present embodiment may generate message information further including the display restriction information indicating to share the message information with the first authorized user, and write the message information in the message storage unit 66 in association with the first legal case.

Then, the display control unit 84 of the present embodiment may display, for the set first authorized user authorized for the first legal case, the message information regarding the first legal case except for the message information not shared with the first authorized user. On the other hand, the display control unit 84 may display all the message information regarding the first legal case for the set second authorized user authorized for the first legal case.

Furthermore, in a case where the user is the second authorized user, the display control unit 84 may display a first display switching button 214, a second display switching button 216, and a third display switching button 218 as illustrated in FIG. 13. The first display switching button 214, the second display switching button 216, and the third display switching button 218 may be examples of display message switching buttons.

In the present embodiment, in a case where the first display switching button 214 is selected by the second authorized user, the display control unit 84 may display all the message information regarding the first legal case in the timeline area 124. In a case where the second display switching button 216 is selected by the second authorized user, the display control unit 84 may display, in the timeline area 124, the message information generated by the first authorized user and the message information shared with the first authorized user among all the message information regarding the first legal case.

Further, when the third display switching button 218 is selected by the second authorized user, the display control unit 84 may display, in the timeline area 124, the message information not shared with the first authorized user among all the message information regarding the first legal case. In this manner, the display control unit 84 of the present embodiment may display the message information for each piece of display authority information.

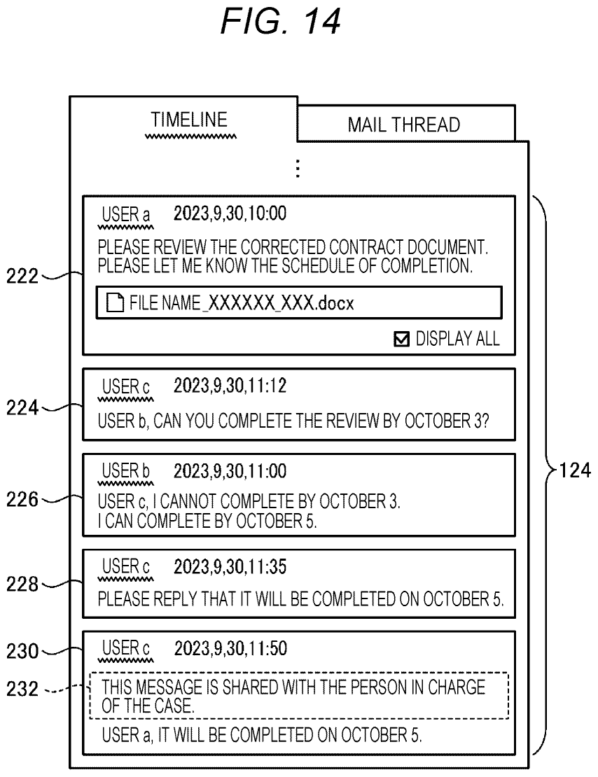

FIG. 14 is a diagram illustrating an example of the timeline area 124 in which message information may be displayed in a case where the user is the second authorized user.

In the example in FIG. 14, in a case where the user is the second authorized user, the display control unit 84 may display eighth message information 222, ninth message information 224, tenth message information 226, eleventh message information 228, and twelfth message information 230.

The eighth message information 222 of the present embodiment may be generated by the first authorized user (person in charge of the case). The ninth message information 224, the tenth message information 226, and the eleventh message information 228 may be generated by the second authorized user (person in charge of legal work or legal manager) and may not be shared with the first authorized user. The twelfth message information 230 may be generated by the second authorized user and is shared with the first authorized user.

The display control unit 84 can display all the message information regarding the first legal case for the second authorized user (person in charge of legal work or legal manager) by displaying in this manner.

Note that, in a case where the user is the second authorized user, the display control unit 84 can additionally display share notification information 232 notifying that the message is shared with the first authorized user on the message information generated by the second authorized user and shared with the first authorized user, such as the twelfth message information 230. Accordingly, the second authorized user can distinguish and recognize the message information shared with the first authorized user and the message information not shared with the first authorized user.

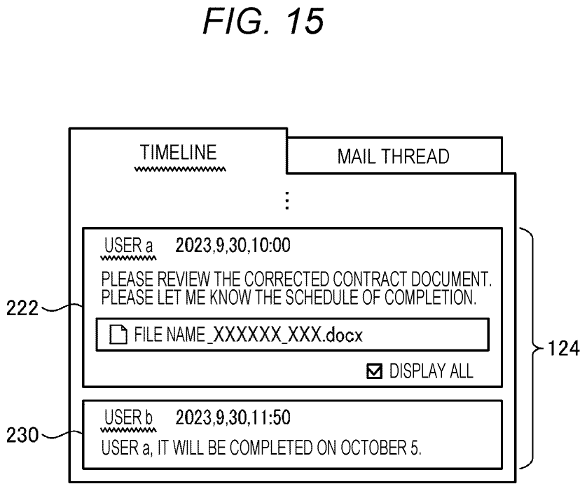

FIG. 15 is a diagram illustrating an example of the timeline area 124 in which message information is displayed in a case where the user is the first authorized user and the person in charge of the case.

In a case where the user is the person in charge of the case, who is the first authorized user, for example, as illustrated in FIG. 15, the display control unit 84 may display only the eighth message information 222, which is transmitted by the first authorized user, and the twelfth message information 230, which is transmitted by the second authorized user and is viewable. That is, in a case where the user is the first authorized user (person in charge of the case), the display control unit 84 may not display the ninth message information 224, the tenth message information 226, and the eleventh message information 228 illustrated in FIG. 14.

By doing so, the display control unit 84 can restrict the message information not shared with the first authorized user from being displayed for the first authorized user. Note that, in a case where the user is the first authorized user, the display control unit 84 may not need to include the share notification information 232 illustrated in FIG. 14 in the message information shared with the first authorized user.

For example, in a case where the person in charge of legal work is in charge of a contract or the like in an unfamiliar field, the person in charge of legal work may ask a superior or a colleague for cooperation, or request another person in charge of legal work to review a document in the legal department. Such exchanges may not need to be disclosed to the person in charge of the case outside the legal department. In this manner, the display control unit 84 can distinguish and display the message in the legal department and the message to be disclosed to the person in charge of the case outside the legal department, so that the efficiency in work can be improved.

The case management system 10 regarding a legal document according to the present embodiment can perform, for example, processing regarding the following document review support functions.
(1) Executing first analysis processing on a target document, and acquiring related information regarding the target document on the basis of a result of the first analysis processing
(2) Generating review information regarding document information on the basis of second analysis processing (for example, document review processing) executed on the target document

Furthermore, the case management system 10 regarding a legal document according to the present embodiment can have a document preparation support function, in addition to the above-described document review support functions. Here, for example, the document preparation support function includes a function of editing (correcting, adding, deleting, and the like) contents of a support target document and a function of providing information for supporting editing. For example, the following processing can be included.
(3) Executing viewing or editing of the document
(4) Storing the edited document or providing the edited document to a user
(5) Editing additional information (for example, meta-information, comment information, chat information, format information, and the like) of the target document
(6) preparing a new document (including a copy, for example)
(7) Proofreading the target document
(8) Executing various types of processing using a translation display function

The editing function of (3) above may include editing body text of the document, and include, for example, editing the document by the user with reference to at least one of displayed review information or related information. The editing function of (3) above may include, for example, editing using a draft for correction proposal included in the review information. The editing function of (3) above may include, for example, at least one of preparation, proposal, correction, or insertion of a correction draft in a pre-trained model or the like such as large language models (hereinafter, may be referred to as LLM) based on or not based on the review information. The large language models may include, for example, bidirectional encoder representations from transformers (BERT), a generative pre-trained transformer (GPT), and the like, and particularly include ChatGPT or GPT-4. This pre-trained model may be customized or fine-tuned, for example, by additional training according to the field of the document to be handled (mainly the contract document or the legal field in the present embodiment) or the user, by being combined with another pre-trained model that performs processing on input or output, or by another way.

The editing function of (5) above for additional information of the target document may be, for example, a function of generating and editing a draft (for example, a draft of comment or chat information) regarding a reason of editing and a reason why a risk is present, by using LLM included in the information processing device 20 (server) illustrated in FIG. 1, on the basis of at least one of the related information regarding the target document or a result of the document review processing regarding the document information.

Specifically, for example, the comment can be generated by inputting, into the LLM, a prompt including a portion of body text of a document for which an indication is output in automatic processing review, text of the automatic processing review result, and a command to generate an appropriate comment or the like using these. Such a draft may have different contents according to a purpose, for example. A function of preparing wording or a draft such as “comment for requester” for an internal requester or “comment for negotiation” for an external negotiation counterparty may be included. The draft can be changed, for example, by adjusting a prompt at the time of input into the LLM.

The translation function of (8) may include, for example, displaying document information of a document and translation of the document in a parallel translation format, and displaying translation of review information and/or additional information in a parallel translation format, for example. In the translation function of (8) above, for example, an external system may be used for translation of at least one of the document information, the review information, the related information, and the additional information.

For example, information in Japanese to be translated can be transmitted to an external information processing device of an external translation system, information translated into English can be received from a server of the translation system, and the translated information can be displayed to the user. Note that the parallel translation may be preferably displayed in certain units, for example, in units of sections and paragraphs of a contract document, such that an original sentence and a translated sentence that correspond to each other are arranged side by side. This may allow the user to easily review the document. Note that, it may be also possible to include a function of outputting the translated sentence or the parallel translation in a predetermined file format and allowing the user to download the translated sentence or the parallel translation.

A target document acquisition unit according to the present embodiment may acquire a document as a review target document. For example, the target document acquisition unit may receive and acquire document data stored in a storage unit of another device (for example, the terminal device 30 illustrated in FIG. 1, an online storage service, or the like) via the network 40. In addition, the target document acquisition unit may receive and acquire a document file attached to an electronic mail, or may receive and acquire a document file transmitted from a chat system or an SNS outside the system. Furthermore, the target document acquisition unit may acquire a document (for example, document information) newly prepared in the information processing device 20 or service and stored in the storage unit.

A first analysis processing unit of the present embodiment may acquire related information regarding the target document. The first analysis processing unit may execute, for example, first analysis processing and acquire related information on the basis of a result of the obtained information. The first analysis processing unit may extract, for example, information that is included in the target document and is necessary for analysis. Various techniques can be adopted as a method for extracting information from the target document. For example, the method may include performing keyword search of a document and extracting characters and numerals and the like included in the vicinity of the keyword, and extracting information by at least one of morphological analysis, syntax analysis, semantic analysis, and context analysis. In addition, examples of the method may include natural language processing using machine learning, in particular, inputting data related to the review target document and a command (prompt) capable of extracting information from the review target document into large language models, and obtaining a necessary output, and the like.

In addition, the first analysis processing unit may perform processing on the document data before the above processing. For example, information necessary for analysis of text data or the like related to body text of the document may be extracted from the received document. It may also be possible to perform processing of extracting text data related to the body text of the document from image data such as PDF and TIFF by processing such as OCR. Furthermore, the target document may be divided on the basis of appropriate units, for example, units such as sections, paragraphs, items, or the like of a legal document. These pieces of processing may be performed in the first analysis processing unit. Alternatively, the processing may be performed by another processing unit of the service or an information processing device outside the system. In addition, as for the timing of the processing, the processing may be performed at the time of the first analysis processing. Alternatively, the processing may be performed after the file may be stored in the storage unit and before the first analysis processing is started.

The first analysis processing unit of the present embodiment may use, for example, information extracted by the method described above to acquire a determination result of a contract type, which is an example of the related information, from the body text of a target contract document that is the target document. Thereafter, the first analysis processing unit may acquire, for example, information regarding another contract document of a type same as or similar to the target contract document from the related information stored in the storage unit.

For example, when the contract document is divided in units of provisions, the first analysis processing unit may give, as attribute information, to each of the divided provisions, result information (for example, a provision ID indicating a content meant by the provision and a type of the provision, and the like) analyzed in the first analysis processing, in addition to the related information. According to this configuration, when the user selects a provision of the contract document as a review target, the first analysis processing unit may refer to the attribute information given to the selected provision, and can search the storage unit for a provision having a high degree of relevance, specifically, having the same provision ID, and present the provision to the user.

A second analysis processing unit of the present embodiment may generate review information regarding document information. For example, the second analysis processing unit may use document information of the target document acquired by the target document acquisition unit to execute the second analysis processing regarding a risk included in the document information, and acquire the review information.

Various techniques can be adopted for the second analysis processing (hereinafter, the second analysis processing may be referred to as document review processing). In the document review processing, for example, the review information may be generated on a rule basis using the extracted information. Furthermore, in the document review processing, it may also be possible to use a pre-trained model such as large language models (LLM) that may receive the extracted information as an input and outputs corresponding document review information. Furthermore, it may also be possible to adopt a combination of the rule-based method and the pre-trained model.

The review information generated by the document review processing executed by the second analysis processing unit of the present embodiment may be generated on the basis of information obtained by analyzing the target document, for example, on the basis of a standard applied to the document (for example, standard information stored in the storage unit, including rules, laws, customs, and the like).

For example, the review information of a contract document may include the following.

(1) Indication of whether the terms included in the document (the contract document in the present embodiment) are advantageous or disadvantageous for the user or the organization (party) to which the user belongs (2) Reference information such as guidelines for amendments and deletions to the terms included in the contract document and draft sentences for amendments (3) Indication that an item to be normally included in the contract document is missing, and proposal of an item and a draft to be added (4) Information about the degree of importance and the degree of recommendation of each review result item

In a case where the target document is a contract document, the review information exemplified in (1) to (4) above and the like may be referred to as contract review information. By using the above information, the user can easily grasp a legal risk included in the contract document and perform contract review including correction proposal. Furthermore, the review information may include format information indicating, for example, whether a format of text in the target document meets a standard, and information about whether a prescribed term is used, for example.

The information about the standard applied to these documents may be set by a vendor of the service, or may be set by a user or an organization to which the user belongs. For example, the user can register a standard indicating an examination standard of a contract document of the user's own company and a draft or an indicated matter related to the standard in the service, and use the standard and the draft or the indicated matter for the document review processing.

Although the embodiments of the present disclosure have been described in detail above, these embodiments have been presented as examples, and are not intended to be limited to individual embodiments. The embodiments can be modified by various additions, changes, replacements, partial deletions, combinations, and the like without departing from the technical idea of the present invention. These embodiments and modifications thereof are included in the invention described in the claims and an equivalent scope thereof.

What is claimed is:

1. A computer-implemented information processing method performed by one or more processors, the method comprising:
storing, for each of at least one legal case, one or a plurality of pieces of message information each including at least displayed content and time information; and
arranging and displaying message information regarding a first legal case, which is one of the legal cases, among the one or the plurality of pieces of message information as information regarding the first legal case on a basis of time indicated in the time information.

2. The information processing method according to claim 1, further comprising:
receiving, as the message information, an input of a chat message from at least one user in association with the first legal case, generating chat message information including the chat message that has been input, and storing the chat message information in association with the first legal case.

3. The information processing method according to claim 2, wherein a document file is stored for each of the legal cases, and
wherein the message information including information specifying the document file corresponding to the first legal case is generated.

4. The information processing method according to claim 2, wherein the message information including a mention that designates a user is generated.

5. The information processing method according to claim 1, wherein, as the message information, one or a plurality of pieces of update operation information including content of an update operation on case information related to the corresponding legal case and operation time information indicating time of the update operation is/are stored for each of the legal cases, and
wherein update operation information regarding the first legal case is displayed as the message information.

6. The information processing method according to claim 1, wherein, as the message information, one or a plurality of pieces of mail information is/are stored for each of the legal cases, and
wherein mail information regarding the first legal case is displayed as the message information.

7. The information processing method according to claim 2, wherein the displayed message information includes at least two of (i) the chat message information, (ii) file information identifying a document file associated with the first legal case, and (iii) email information associated with the first legal case.

8. The information processing method according to claim 7, wherein only email information regarding the first legal case is displayed to a user authorized for the first legal case in a mail thread area different from a timeline area in which chat message information and update operation information are displayed.

9. The information processing method according to claim 2, wherein a first authorized user to whom display authority of a first level is given and a second authorized user to whom display authority of a second level higher than the first level is given are set as the users for each of the legal cases,
wherein, in a case where the second authorized user authorized for the first legal case generates the message information, an input of display restriction information indicating whether or not to share the message information with the first authorized user is further received, and
wherein, for the set first authorized user authorized for the first legal case, the message information regarding the first legal case is displayed except for the message information not shared with the first authorized user.

10. The information processing method according to claim 1, further comprising collectively creating a plurality of legal cases based on a plurality of uploaded emails.

11. An information processing device comprising:
a storage unit configured to store, for each of at least one legal case, one or a plurality of pieces of message information each including at least displayed content and time information; and
a display control unit configured to arrange and display message information regarding a first legal case, which is one of the legal cases, among the one or the plurality of pieces of message information as information regarding the first legal case on a basis of time indicated in the time information.

12. A non-transitory computer-readable medium storing instructions that, when executed by one or more processors, cause the one or more processors to function as:
a storage unit configured to store, for each of at least one legal case, one or a plurality of pieces of message information each including at least displayed content and time information; and
a display control unit configured to arrange and display message information regarding a first legal case, which is one of the legal cases, among the one or the plurality of pieces of message information as information regarding the first legal case on a basis of time indicated in the time information.
